(19) United States
(12) Patent Application Publication
(10) Pub. No.: US 2014/0081674 A1
(43) Pub. Date: Mar. 20, 2014

(54) Vehicle Title Tracker Method and Apparatus

(71) Applicant: Anthony B. Hildreth, Aurora, IL (US)

(72) Inventor: Anthony B. Hildreth, Aurora, IL (US)

(73) Assignee: INSURANCE AUTO AUCTIONS, INC., Westchester, IL (US)

(21) Appl. No.: 14/030,324

(22) Filed: Sep. 18, 2013

Related U.S. Application Data
(60) Provisional application No. 61/702,411, filed on Sep. 18, 2012.

(51) Int. Cl. G06Q 40/08

(52) U.S. Cl. CPC G06Q 40/08
USPC 705/4

(57) ABSTRACT

A method and apparatus for guiding and tracking a workflow for transferring a title of a damaged vehicle from an owner to an insurance company and then to a salvage company. The method is provided via a website that identifies the specific requirements for the vehicle transfer depending on the state in which the vehicle is titled, the existence of any liens on the vehicle, and the state in which the vehicle will be sold. The user identifies the documents and things that will be needed for the transfer and monitors the completion of each task in the process.

### CROSS-REFERENCE TO RELATED APPLICATION

This application claims the benefit of U.S. Provisional Patent Application Ser. No. 61/702,411, filed Sep. 18, 2012, which is incorporated herein by reference.

### BACKGROUND OF THE INVENTION

1. Field of the Invention

The present invention relates generally to a method and apparatus for tracking and guiding the workflow for transferring the ownership of a vehicle, and more particularly to an automated system to tracking and guiding the transfer of a vehicle title of a vehicle that has been damaged and determined to be a total loss and which may be sold for its salvage value.

2. Description of the Related Art

When an automobile or other vehicle is damaged, for example in an accident or natural disaster, a determination is made as to whether repair of the vehicle is economically feasible. If the cost of repair is great relative to the value of the vehicle, the damaged vehicle may be determined to be a total loss (totaled) rather than having the damaged vehicle repaired for continued use by the owner. Typically, an insurance company that insures the vehicle which is determined to be a total loss takes ownership of the damaged vehicle as part of the insurance claim settlement with the vehicle owner. The insurance company generally sells the damaged vehicle for its salvage value. In some instances the owner of the vehicle may wish to retain the damaged vehicle. In other instances, the vehicle may have been stolen and not recovered.

In particular, when a vehicle is declared a total loss, the insurance company takes ownership of the vehicle by issuing a payment in the amount of the actual cash value (ACV) of the vehicle to the vehicle owner and any lien holder in exchange for a properly executed title for the vehicle. The title must be signed by the owner and any existing liens must be released by the lien holder. Upon receipt of the title, the insurance company takes legal ownership of the vehicle by transferring the title to the insurance company's name and branding the title as salvage per the regulations of the state in which the vehicle is being sold. Once this process is complete the vehicle is sold (typically by a salvage vehicle auction) to a buyer who is legally entitled to purchase salvage vehicles.

The specific process and required documentation differs in each situation and is determined by several factors including:
The number of owners listed on the title of the vehicle
The state in which the vehicle is titled
The state in which the vehicle to be sold
Whether or not a lien exists on the vehicle
Whether or not the owner owes more to the lien holder than the vehicle is worth (commonly referred to as “upside-down”)
Whether the owner is deceased
Whether the owner is retaining the vehicle or releasing it to the insurance company
Whether the vehicle was damaged or stolen

The process of paying off the lien, receiving the title, and paying the owner and lien holder is usually executed remotely and documents (i.e. titles, powers of attorney, checks and lien releases) are typically exchanged via US mail or an express delivery service. A proper exchange requires careful coordination between the:
Insurance company,
Vehicle owner,
Lien holder,
Salvage auction entity, and
State motor vehicle department.

This coordination must be very carefully orchestrated to ensure that each party receives appropriate and complete documentation in a timely fashion. The number of variables in this process combined with the complication of having to execute this process remotely by exchanging paper documentation via mail or express delivery often results in process exceptions such as missing or improperly executed documentation. These process exceptions prevent insurance companies from legally transferring and branding vehicle titles and lead to costly remediation and delays in selling these vehicles.

Multiply this process by the number of vehicles involved and the magnitude of the problem becomes evident. Every year insurance companies in the United States declare more than three million damaged and stolen vehicles as total losses.

The title procurement processes of the ownership transfer for the vehicles subject to total loss claims can be resource intensive, can affect cycle time in the processing of the vehicles, and can lack visibility at the processor and management levels. Many insurance companies struggle with the title procurement process because they lack adequate tracking systems to prompt and/or track the steps and to provide visibility into the process. Without solid process control, it is assured there will be variations and inefficiencies, which affect productivity, cycle times and ultimately may decrease salvage returns. In many cases these inefficiencies can cause delays in settlement, putting at risk a positive experience for the policy holder or claimant; with a poor experience, the loss of a potential or existing policy holder may occur.

### SUMMARY OF THE INVENTION

The present invention provides a workflow monitoring and guiding method and apparatus that tracks the workflows involved in acquiring and processing ownership documents for vehicles. The workflow monitoring and guiding method and apparatus may be provided to the staff of an insurance company via website that provides the guidance needed to reduce or eliminate the problems that have occurred during the vehicle title transfer process. Although the present workflow monitoring and prompting method is disclosed for use with transfer of damaged vehicles, the method and apparatus can be used for ownership transfer documents of other items as well or can be used to track ownership transfer of vehicles for purposes other than salvage of the vehicle, for example an owner retained vehicle or an unrecovered theft. The preferred embodiment is used for monitoring and prompting the workflows associated with acquiring and transferring ownership of damaged vehicles for salvage.

The present method and apparatus provides a tool for use by an insurance company or other company to identify the documents and things needed for each situation involving transfer of a damaged vehicle and for tracking the status of those documents and things along the title transfer process.

In one embodiment, a computer executed method receives information on the vehicle, state, insurance company, etc. and generates a listing of the steps to be performed to transfer the title as guidelines for completing the vehicle transfer. A computer system determines what documents are required for the particular vehicle transfer, what steps will be necessary, and what parties will need to be contacted. The computer executed method monitors the process, tracks the steps that have been completed, and provides reminders to the user of those steps that still need to be completed.

An embodiment of title tracker method and apparatus is accessible as a feature via an internet web site, for example such as a customer facing site of the auction service that provides tools for managing inventory with the auction service, assigning, tracking and communicating with branch offices, reviewing past inventory details, and the like. One example of such a web site is the CSAToday™ web site. The web site may have a web-based workflow driven title procurement tool. An exemplary embodiment is offered by a salvage auction company, although other providers of the method and apparatus are also possible. The method and apparatus serve as a tool to augment an insurance company's title procurement process for total loss vehicles. With its workflow engine driving the task and the allotted times, title tracker automatically moves tasks forward and notifies management when tasks are not completed in the allotted time. In a preferred embodiment, there is a high level of integration with an enterprise salvage management system which enables the title tracker method and apparatus to be used to manage the entire title procurement process and salvage recovery from start to finish.

The title tracker method and apparatus may enable collaboration and partnership between a salvage auction company and an insurance company and increase an understanding and knowledge of the user's and industry's needs. The method and apparatus may provide an intuitive, efficient, streamlined, and integrated tool, which is feature rich and customizable.

Each insurance company may have their own internal procedures and requirements. The title tracker method and apparatus can be tailored to meet the requirements of different insurance companies. It is within the scope of the invention that the system is customized, or personalized, for each different insurance company. A generic version of the present system and method are also provided, which can be used by users at different insurance companies or different divisions. The steps performed by the generic and customized versions of the system are generally the same for each, but the information required at sections of the method may differ as between the different customized versions and as compared with the generic version.

An optional workflow is provided for users who prefer to have an outside company handle some aspects of the title transfer process. In a standard workflow, personnel of the insurance company follow a workflow to verify and execute the title transfer documents prior to sending the documents to a vehicle auction company. In a service provided by an outside company, such as the vehicle auction company, the titling documents of vehicle owners and any lienholders are sent to the outside company for verification in order to obtain an executable title document. The outside company performs the steps needed to obtain the documents, and can perform any extra steps as needed. The outside company receives the documents, verifies all necessary documents and executes the documents.

### BRIEF DESCRIPTION OF THE DRAWINGS

FIG. 1 is screen shot of task action results for tasks being tracked by the present system or method;

FIG. 2 is a screen shot of a file entry screen for initiating the vehicle transfer process;

FIG. 3 is a screen shot showing file details of a file for a vehicle transfer;

FIG. 4 is a screen shot showing file notes on the vehicle transfer file;

FIG. 5 is a schematic diagram of a computer system in use to perform the present method;

FIG. 6 is a diagram entitled Standard Task Flow which represents a workflow by an insurance company internal processing department for a title transfer;

FIG. 7 is a diagram entitled Title Direct Task Flow which represents a workflow of an optional handling of title transfer documents by a company outside the insurance company;

FIG. 8 is an enlarged fragmentary screen shot of an opening page of the user interface;

FIG. 9 is a screen shot of a dialog box for a new file;

FIG. 10 is a screen shot of a dialog box for claim information;

FIG. 11 is a screen shot of a dialog box for insurance and owner information;

FIG. 12 is a screen shot of a dialog box for vehicle information;

FIG. 13 is a screen shot of a dialog box for document tracking information;

FIG. 14 is a screen shot of a dialog box lienholder information;

FIG. 15 is a screen shot of a dialog box for payment information;

FIG. 16 is a screen shot of a dialog box for comments;

FIG. 17 is a screen shot showing searching for a tracker file;

FIG. 18 is a screen shot of a dialog box showing a sorting function;

FIG. 19 is a screen shot of a dialog box for filtering displayed results;

FIG. 20 is a screen shot of a tracker file and its contents;

FIG. 21 is a screen shot of a details view of a tracker file; and

FIG. 22 is a screen shot of a notes view of a tracker file.

### DETAILED DESCRIPTION OF THE PREFERRED EMBODIMENTS

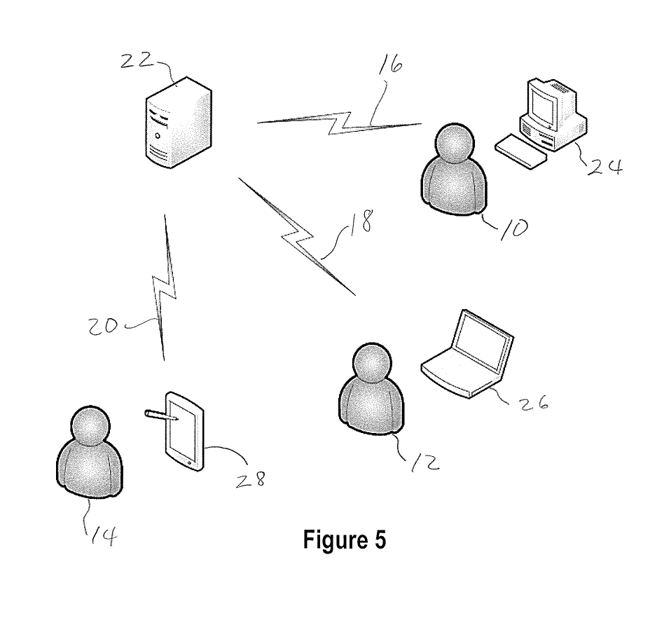

As shown in the schematic diagram of FIG. 5, users 10, 12 and 14 at insurance companies seek to obtain guidance on the transfer of titles of damaged vehicles from the vehicle owner to the insurance company and then to a salvage company. The users use one or more network connections 16, 18 and 20 such as the internet and/or other network to access one or more servers 22 using user computer devices 24, 26 and 28. The users 10, 12 and 14 can be from a single insurance company or from different insurance companies or from other companies or entities. The users 10, 12 and 14 can use different computer devices to access the server or servers, such as a desktop computer 24, laptop computer 26, notebook computer, tablet computer 28, smart phone, kiosk computer or other computer device. The computer devices each have a processor for executing programs and may have local data storage or remote data storage for the browser or other program executed on the computer device to communicate over the network connection to the server 22. The server 22 has one or more processors to execute programs, which program provides a user interface for use by the computer devices 24, 26, and 28 to interact with the users 10, 12 and 14. The server 22 has data storage media therein or connected in communication thereto which media stores the programs as well as data include databases of information relating to vehicle titles, state department of transportation requirements, insurance company requirements, title transfer requirements, and other information as necessary to perform the present method.

### Technical Logistics

An exemplary embodiment of the method and apparatus uses several tools to implement this application including:

Application Server—The server of a preferred embodiment is programmed using Microsoft based technology such as .Net.
Database—The databases are implemented for this method and apparatus with Microsoft SQL Server.
Supporting Applications—Supporting applications include applications that are delivered using Microsoft Silverlight technology.

An embodiment of the method and apparatus is available to users via a web site. Its key features include:
Claim File Import
Standard Lien & Non-Lien Workflows
Title Direct Workflows—which are separate for lien and non-lien transfers
Configurable Time Allotments
State Specific Document Types & Tracking
Title Problem Notification & Task Generation
The company or user Title Statuses and Notes Visibility
User Notes Visibility settings permit the notes to be made visible or not to different entities
Salvage Assignment Integration via a web site
Settlement Notification
Management Escalation
Task Aliases (i.e. renamed to company nomenclature)

A user, for example an employee 10 of an insurance company, learns that a vehicle insured by the insurance company has been damaged. Estimates for repair are obtained and if the estimate is great relative to the value of the vehicle then the vehicle is determined to be a total loss. The user 10 initiates contact with the server 22 using the user computer 24 to begin the process of transferring the title to the vehicle from the owner to the insurance company and then to a salvage auction company that will sell the vehicle at auction. Other scenarios are of course possible with different entities playing different rolls and a different disposition for the vehicle. For example, the owner of the vehicle may wish to keep the vehicle and have it repaired rather than transfer the vehicle to the insurance company. The insurance settlement in an owner retain situation requires different documents and things.

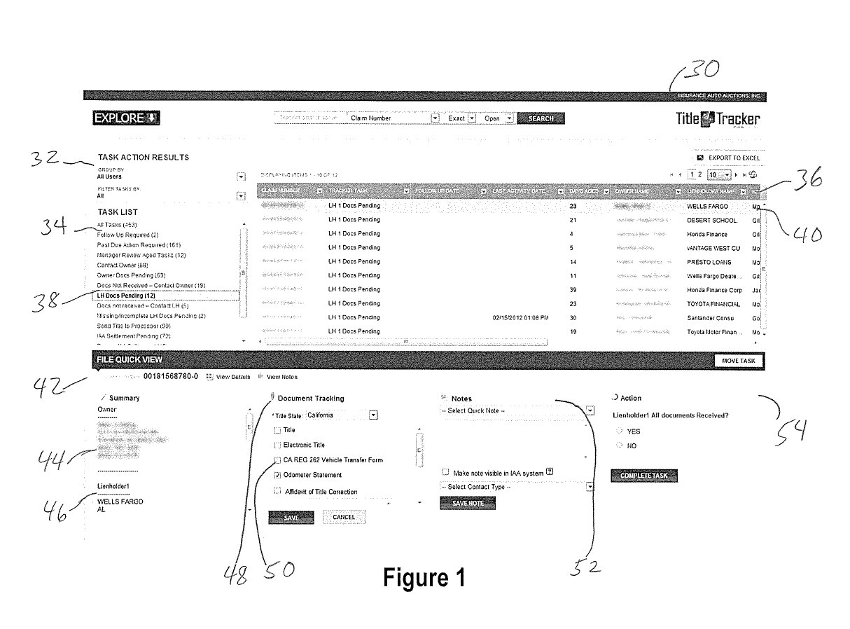

The user/employee 10 uses a user interface at the website to track the transfer of the vehicle. The user 10 may be handling many such transfers on behalf of the insurance company, which could be daunting if performed without guidance and tracking. An example of the user interface 30 to provide the guidance and tracking to the user is shown in FIG. 1.

In FIG. 1, a website view 30 provides information to a user, such as an employee of an insurance company. The view 30 includes task action results 32 that identify the number of tasks 34 to be performed, broken down by category and the number of lien holder documents pending, as shown in the left column. In particular, the tasks 34 are shown as all tasks—of which 453 are indicated, follow up required—of which two are indicated, past due action required—of which 161 are indicated, manager review aged tasks—of which 12 are indicated, contact owner—of which 88 are indicated, owner documents pending—of which 63 are indicated, lienholder documents pending—which is highlighted at 38 for display in the right portion 36 and of which 12 are indicated, documents not received—contact lienholder—of which 5 are indicated, missing incomplete lienholder documents pending—of which 2 are indicated, send title to processor—of which 90 are indicated and IAA settlement pending—of which 72 are indicated. Other tasks are off screen in this view.

The right portion 36 of the display lists the claims for the task that is highlighted to the left 38 by claim number, the task that is being tracked (here the lien holder (LH) documents pending), follow up date, last activity date, the days aged, the owner name, and the lienholder name.

For a highlighted claim 40 on the claim list 36, a lower portion 42 of the screen shows summary information including owner name and contact information 44, and lienholder information 46. In a document tracking portion 48, the title state is shown and a listing 50 of the documents which may be required in the more common situations for a title transfer in the specific state shown. For instance, the Affidavit of Correction form is listed as an option for use if the title needs to be corrected. If no correction is needed, the form is not used. The user is guided by a list 50 of suggested documents, not all of which will be needed in every instance. In some embodiments, the forms required for less common scenarios may not be listed. For instance, forms necessary for transferring a vehicle from a deceased owner are used infrequently and may not be listed. In the example, the vehicle is titled in California and a title transfer requires either an electronic title or a paper title, a vehicle transfer form, an odometer statement and an affidavit of title correction. Check boxes are provided in the list 50 for checking by the user as each of these items is obtained in the process. In a notes section 52, notes about the claim may be entered. In an action portion 54, the user is asked whether the lienholder documents have been received. Other information may be provided as well.

Using this system as a tool, the user is provided with information indicating what is required for that vehicle to be transferred according to that state's rules. The user is able to indicate when each task 40 has been completed. The user can track the progress not only of this claim, but can also track the progress of the tasks for each claim. More importantly, the user is able to track many claims and the different aspects of the many claims without the tasks required for the claims becoming lost in the volume of claims being handled.

The benefits of using the method and apparatus include:
Reduced Variation
Process Visibility
Feasible Cycle Time Reduction
Increased Productivity
Management Visibility & Reporting
Feasible Resource Savings
IAA Integration

The Title Tracker method and apparatus of one embodiment is a tool available via a web site, such as CSAToday, and is designed to manage title acquisition.

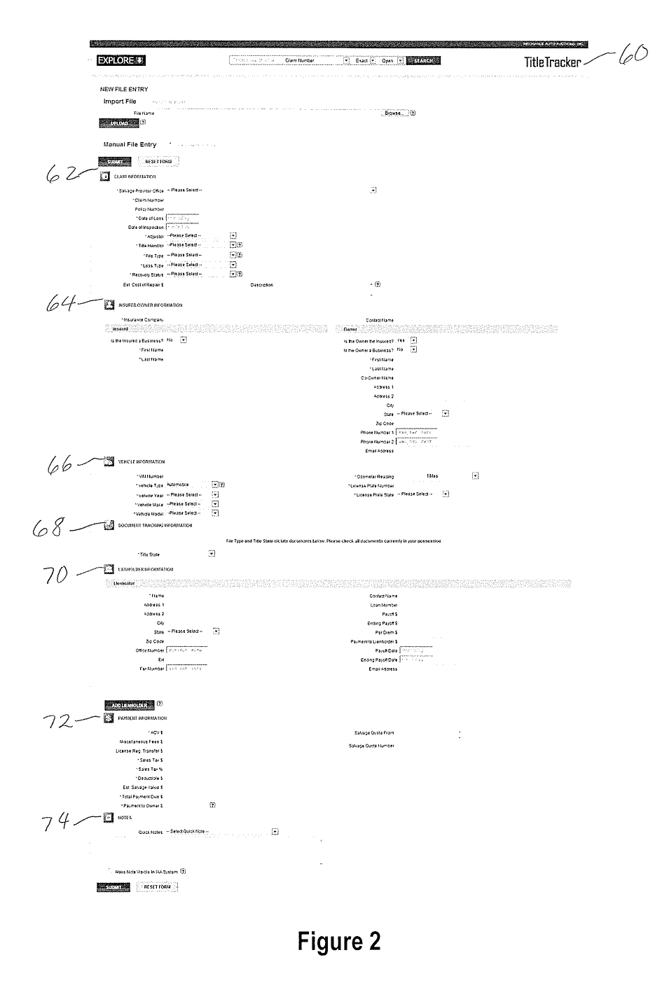

Using the program, a Title Tracker file 60 is created by an adjuster via a New File Entry command. See FIG. 2 for example. A data entry screen opens. A Total Loss File from the company or a Stock file that includes vehicle information compiled by the auction service can be used to populate the entry page fields of the data entry screen, or the data can be typed or copy/pasted to the form by the user. The form includes claim information 62 such as the claim number, policy number, loss type and recovery status. An insured and owner information portion 64 is provided. The vehicle information is entered at a vehicle information portion 66. The document tracking information is populated in a document tracking portion 68 based on the vehicle title state. The lienholder information is also provided in a lienholder information portion 70. Payment information is provided on the form in a payment information portion 72. Finally, a notes section 74 is available for the user to enter any additional information. Once completed, the form 60 is submitted and becomes a claim entry. When created the file is assigned to the appropriate Title Handler, a user who performs the steps of the method and system to perform the tasks in the title transfer.

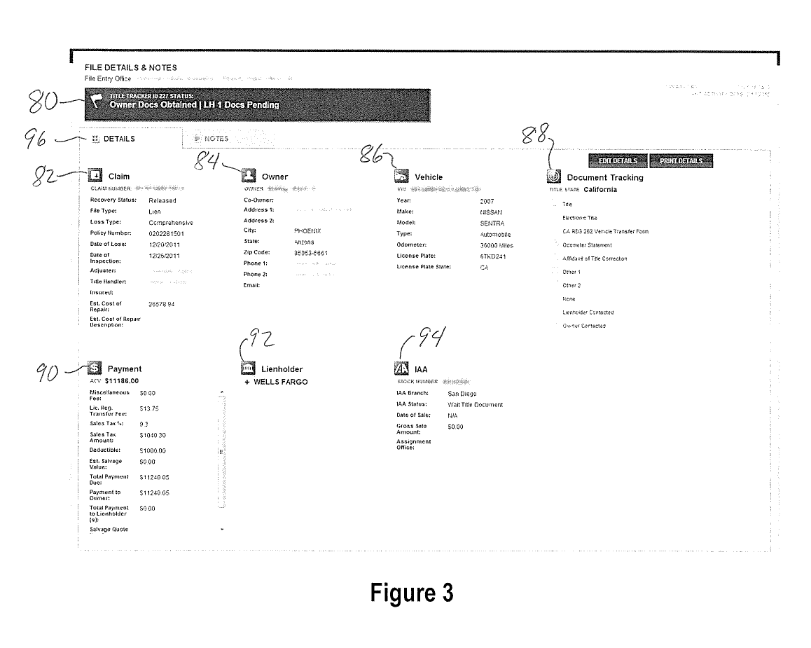

A display 80 of the information for a claim is provided in FIG. 3. The information is divided into sections, including a claim section 82, an owner section 84, a vehicle section 86, a document tracking section 88, a payment section 90, a lienholder section 92, and, in some embodiments, a section 94 for a salvage auction company or service. Other sections are of course possible. These sections are provided in the details tab 96 of the view screen.

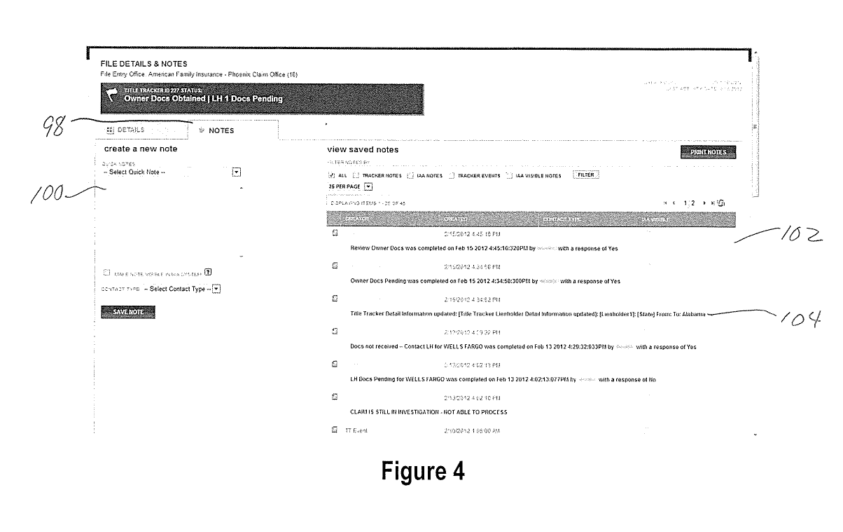

In a notes section 98 of the view screen for the claim as shown in FIG. 4 is a section 100 to save a new note and a listing 102 of saved notes 104 for the claim. The notes 104 can be sorted by different characteristics, as can many of the other information on the display screens.

A Title Tracker file 60 begins its work flow in appropriate task(s) 40 necessary to obtain an executable title for the damaged vehicle. Each task 40 is a status describing the next action necessary. A file may begin in one task 40 or several depending on the selections made at entry and the file type of lien or non-lien. For example a lien file begins two tasks flows: the first to track progress of obtaining lienholder paperwork, and the second to track progress in obtaining owner paperwork. Each task flow progresses independently from the other, advancing as tasks are completed or when the company, for example a branch office, receives executable documents.

As each task 40 is worked, follow-up dates can be set, documents obtained can be updated, and notes are made to track progress. Notes 52 made in the work files of the system are visible and tracker notes can be flagged to be visible in the system. If a title problem is identified at the salvage auction company, the tracker file 60 will be added to the Title Problem task bucket for added visibility, and remain in its current task to track progress on obtaining the necessary paperwork.

Task buckets designed to assist in managing priorities are provided as follows:
Follow-Up Required: Tasks have reached their set Follow Up date.
Past Due Action Required: Tasks have exceeded the customer pre-set days to be worked, with no activity or follow-up date set.
Manager Review Aged Tasks: Tasks have exceeded the customer pre-set days for task; email is sent to Manager to advice of aging task.

A file remains in current task when added to above task buckets.

When the company, for example a branch office, receives executable documents, the tracker file will automatically advance to the end of the task flow for that task, pending sale and the settlement invoice. The file will also enter Issue Payment & LH (lienholder) Release Pending tasks if not already completed, as these tasks prompt owner payment & LH payments to be made.

Once the sale is complete and the settlement invoice is processed the file automatically moves to Review Settlement, review information as needed and complete task to close file.

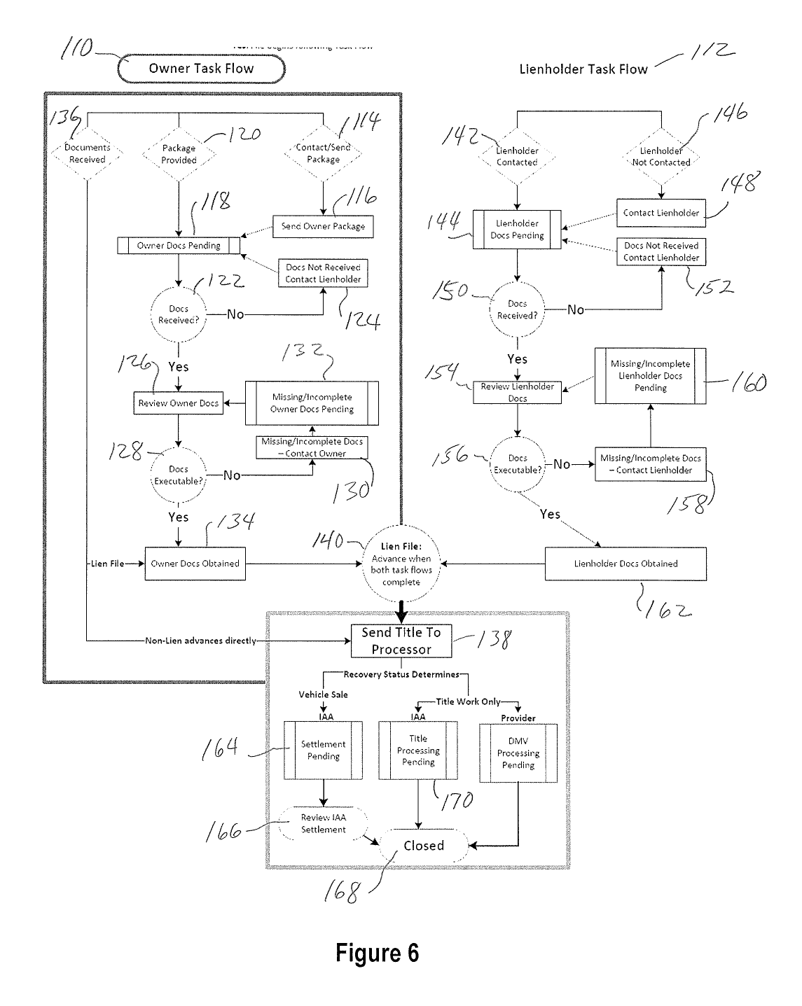

FIG. 6 is a diagram of a workflow performed using the present method and system by a user or by a department within an insurance company in preparing documents for transfer of the title of a damaged vehicle to the insurance company and ultimately to a vehicle auction company. The diagram is entitled Standard Task Flow and includes an owner task flow 110 and a lienholder task flow 112. The owner task flow 110 begins with a step 114 to contact the owner of the vehicle and send a package of the necessary documents for transfer of the title. In step 116, the owner documents are sent. Once the documents are sent at 116, the process moves to a step 118 of owner documents pending. A step 120 is also provided of determining if the package has been provided, which leads to the step 118. An inquiry is made at 122 as to whether the documents have been received. If not, a step 124 finds that the documents have not been received and that the lienholder should be contacted. If the documents have been received at 122, a review of the documents is performed at 126. A determination is made as to whether the documents are executable at 128. If not, the missing or incomplete documents are identified and the owner is contacted at 130. After the owner is contacted, the process is at step 132, indicating that the missing or incomplete owner documents are pending. The step 132 returns to step 126 to review the documents when different documents are received. Once the documents are found to be executable, the process proceeds to step 134 indicating that the owner documents have been obtained. The process also includes a determination at 136 as to whether documents have been received. If so, a lien file is provided to the step 134 and any non-lien documents are provided to a step 138, which is a file to send the title to a processor. The owner documents of step 134 are provided to a lien file at 140.

The lienholder task flow 112 includes the following. The lienholder for the vehicle is contacted at 142. Once contacted, the process moves to the step 144 indicating that the lienholder documents are pending. The process may also be started at step 146 which determines that the lienholder has not been contacted. The process proceeds to a step 148 of contacting the lienholder, after which the process proceeds to step 144. An inquiry is made as to whether the documents have been received, at 150. If not, a step 152 provides that the lien documents have not been received and a further contact is made with the lienholder. This proceeds to the step 144 that the lienholder documents are pending. Once the documents have been received, a review is performed of the received documents at step 154. A determination is made as to whether the documents are executable at 156. If not, the missing or incomplete documents are identified and the lienholder is contacted at 158. Once the contact is made, the process proceeds to step 160, indicating that the missing and incomplete documents are pending. This step proceeds to the investigation of the documents at step 154. Once the documents have been found executable at step 156, the process moves to the step 162 indicating that the lienholder documents have been received. The completed lienholder documents are sent to the lien file at 140.

After both owner and lienholder task flows have been completed, the lien file 140 is advanced by sending the file to the processor at 138. The title work is split at an indication of determining the recovery status. A vehicle sale branch proceeds to an auction service that moves to a step 164 to indicate that the settlement is pending. A step 166 reviews the settlement of the auction service, which, when completed moves to a step 168 indicating that the process is closed. However, the other branches require completion. In a title work branch, a first sub-branch proceeds to the auction service to a step 170 that indicates that the title process is pending. A provider sub-branch includes a step 172 that the department of motor vehicles processing is pending. When both steps 170 and 172 have been completed, they proceed to the closed step 168.

Thus, a flow is provided for obtaining the necessary documents for transfer of the vehicle. The flow is implemented using computer devices.

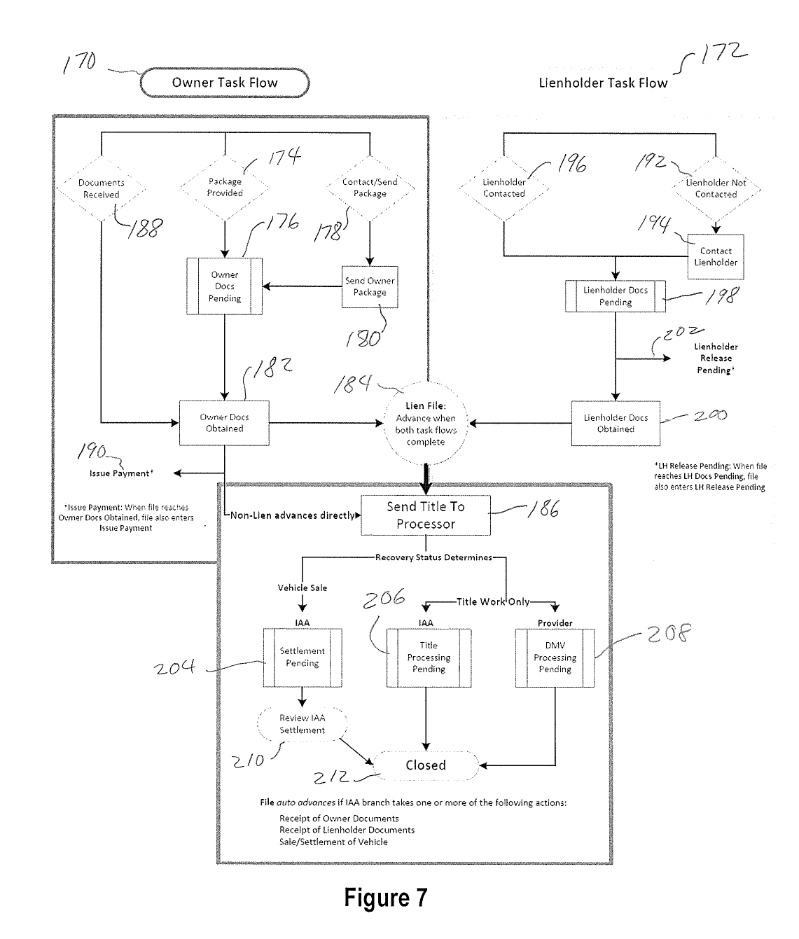

In an alternate embodiment, the vehicle auction service or a third party can provide the document verification and execution service. An example of the workflow for this embodiment is provided in FIG. 7 in a diagram entitled Title Direct Task Flow. This workflow also includes a portion 170 for owner task flow and a portion 172 for lienholder task flow. The number of steps required for the embodiment of FIG. 7 is significantly reduced for the users at the insurance company, since the outside service handles many of the steps. As such, the insurance company may elect to outsource the document handling steps and realize the efficiencies of the workflow of FIG. 7.

In particular, the owner task flow 170 includes a determination that a package of documents has been provided, at 174. This proceeds to an owner documents pending step 176. The process also includes a step 178 to contact the owner and send a package of documents. The step 180 sends the documents to the owner. The process moves to the step 176 of pending documents. Once the owner documents have been obtained, as indicated by step 182, the lien documents are forwarded to a lien file at 184 and the non-lien documents are provided to a processor at 186. The owner task flow also includes a step of receiving the documents at 188, which transfers the owner documents to step 182. A payment is issued at 190.

In the lienholder task flow 172, a determination is made as to whether the lienholder has been contacted, at 192. If not, the lienholder is contacted at 194. If the lienholder was contacted as determined at 196. Both steps 194 and 196 lead to step 198 where the lienholder documents are pending. Once the documents are obtained at step 200, they are sent to the lien file 184. A lienholder release is pending at 202.

The lien file is sent to the processor at 186, where the process splits into a vehicle sale by an auction company that leads to a settlement pending step 204. The title working portion includes title processing at 206 by the auction service and DMV processing 208 by the provider. After the sale, the auction service reviews the settlement at 210 and all branches converge at a closed step 212.

The use of an outside service is referred to in the example as title direct. The steps performed in title direct are as follows:

### Title Direct Task Definitions

The following phrases may be used herein.

Pending Agreed Value: Settlement value has not been reached with owner. Complete task when settlement value is agreed to begin the task flow.

Send Owner Package: Total loss package and instructions need to be provided to owner. Complete task when owner contact is complete, and package and instructions are provided.

Owner Docs Pending: Owner documents are en route. Complete task if owner paperwork is received, task will automatically advance when branch office receives owner paperwork.

Issue Payment: Owner documents are received and executable, owner payment needs to be made. Complete task when owner payment is complete.

Title Problem: Branch office has identified a title problem. File remains in current task as well as Title Problem, and a link to CSAToday web site Title Problem List. Detail Review page is available in the action box. File is removed from Title Problem bucket when the branch office receives necessary paperwork and resolves the title problem.

Contact LH (lien holder): Lienholder contact is needed. Complete task when contact is complete and documents are en route.

LH Release Pending: Letter of Guarantee or Lienholder Letter is en route, complete task once received and lienholder payment is complete.

LH Docs Pending: Lienholder documents are en route. Complete task if lienholder paperwork is received, task will automatically advance when branch office receives lienholder owner paperwork.

Send Title to Processor: Executable title was received internally and needs to be sent to appropriate vendor for processing. If IAA Stock exists the Title Transmittal form is available in Action Box. Release Status determines Action Box options of send title to IAA for sale, or to appropriate vendor to process title.

Company Settlement Pending: Executable documents received, waiting on sale and settlement invoice to be processed. Task will automatically advance when branch office processes settlement invoice.

Review Settlement: Sale information and settlement invoice have been processed, review information as needed and complete task to close file.

Title Processing Pending: IAA Branch processing title for Owner Retained or Unrecovered Theft vehicle, complete task when processed title is received.

DMV Processing Pending: Title paperwork for Owner Retained or Unrecovered Theft vehicle processed directly with DMV or vendor, complete task when process is complete to close file.

Closed Claim File: Closed and canceled files.

### Title Direct Task Flow

Document Tracking ‘Agreed Value Reached?’ response at entry determines starting point:—see FIG. 3

When a branch office receives executable title documents: the tracking file will automatically advance through the work flow for the user. This is true for both the standard task flow and the title direct task flow.

Issue Payment: when a task reaches the Owner Docs Obtained step, the file enters an Issue Payment task, and the task flow continues but the file also remains in the Issue Payment task until an owner payment is made and the task is completed.

Lien holder Release Pending: when a task reaches the LH (lien holder), the Docs Pending file enters the LH Release Pending task, the task flow continues but the file also remains in the LH Release Pending task until the LH payment is made and the task is completed.

### Standard Task Definitions

Pending Agreed Value: a settlement value has not been reached with the owner. The user is to complete the task when a settlement value is agreed to begin the task flow.

Send Owner Package: A total loss package and instructions need to be provided to owner. The user is to complete the task when the owner contact is complete, and package and instructions are provided.

Owner Docs Pending: The owner documents are en route, the user is to complete the task when received. The task will automatically advance if the auction service branch receives the owner paperwork.

Docs Not Received—Contact Owner: The owner documents are en route, but should have been received by now. This task allows the user to sort unresponsive owners into their own task queue. The user is to complete task when the owner contact is complete.

Review Owner Docs: Owner documents are received; review to ensure documents are executable and complete task accordingly.

Missing/Incomplete Docs—Contact Owner: Owner documents received are incomplete or incorrect. The user is to contact the owner for corrected documents, and to complete task when documents are en route.

Missing/Incomplete Docs—Owner Docs Pending: Corrected owner documents are en route, the user is to complete the task when received.

Contact LH: Lienholder contact is needed. The user is to complete the task when the contact is complete and the documents are en route.

LH Docs Pending: Lienholder documents are en route, the user is to complete the task when received.

Doc's Not Received Contact LH: The lienholder documents are en route, but should have been received by now. This task allows the user to sort unresponsive lienholders into their own task queue. The user is to complete the task when the lienholder contact is complete.

Review LH Docs: The lienholder documents are received; the user is to review to ensure the documents are executable and to complete task accordingly.

Missing/Incomplete Docs—Contact LH: The lienholder documents that have been received are incomplete or incorrect. The user is to contact the lienholder for corrected documents, and to complete the task when the documents are en route.

Missing/Incomplete Docs—LH Docs Pending: The corrected lienholder documents are en route, the user is to complete the task when received.

Title Problem: The auction service branch has identified a title problem. The file remains in the current task listing as well as in a title problem listing, and a link to CSAToday Title Problem List Detail Review page is available in the action box. The file is removed from Title Problem bucket when the auction service branch receives the necessary paperwork and resolves the title problem.

Send Title to Processor: An executable title was received and needs to be sent to an appropriate vendor for processing. If the auction service stock exists, the title transmittal form is available in an action box. A release status determines the action box options of send the title to the auction service for sale, or to an appropriate vendor to process the title.

Settlement Pending: The executable documents have been received, waiting on the auction service sale and settlement invoice to be processed. The task will automatically advance when the auction service branch processes the settlement invoice.

Review Settlement: The sale information and settlement invoice have been processed, the user is to review of the information as needed and to complete the task to close the file.

Title Processing Pending: The auction service branch is processing the title for an owner retained or unrecovered theft vehicle, the user is to complete the task when the processed title is received.

DMV Processing Pending: The title paperwork for an owner retained or unrecovered theft vehicle is processed directly with the DMV or the vendor, the user is to complete the task when the process is complete to close the file.

Closed Claim File: Closed and canceled files.

### Standard Task Flow

Document Tracking ‘Agreed Value Reached?’ response at entry determines starting point: New File Entry—see FIG. 2. Import file to populate fields using: total loss file or auction service stock and complete additional required fields or complete fields manually. Use copy and paste functionality—additional help text, mark required fields, include dates and phone numbers, auto format, include auto VIN decode, and use calendar option in date fields.

For document tracking, documents are based on file status (lien or non-lien) and title state. Check off documents already obtained and actions completed to communicate with others where work left off and where to begin.

For title direct, leave this item checked if title paperwork will be sent directly to branch office. Uncheck if title paperwork will be received at the office, and processed directly with vendor or DMV.

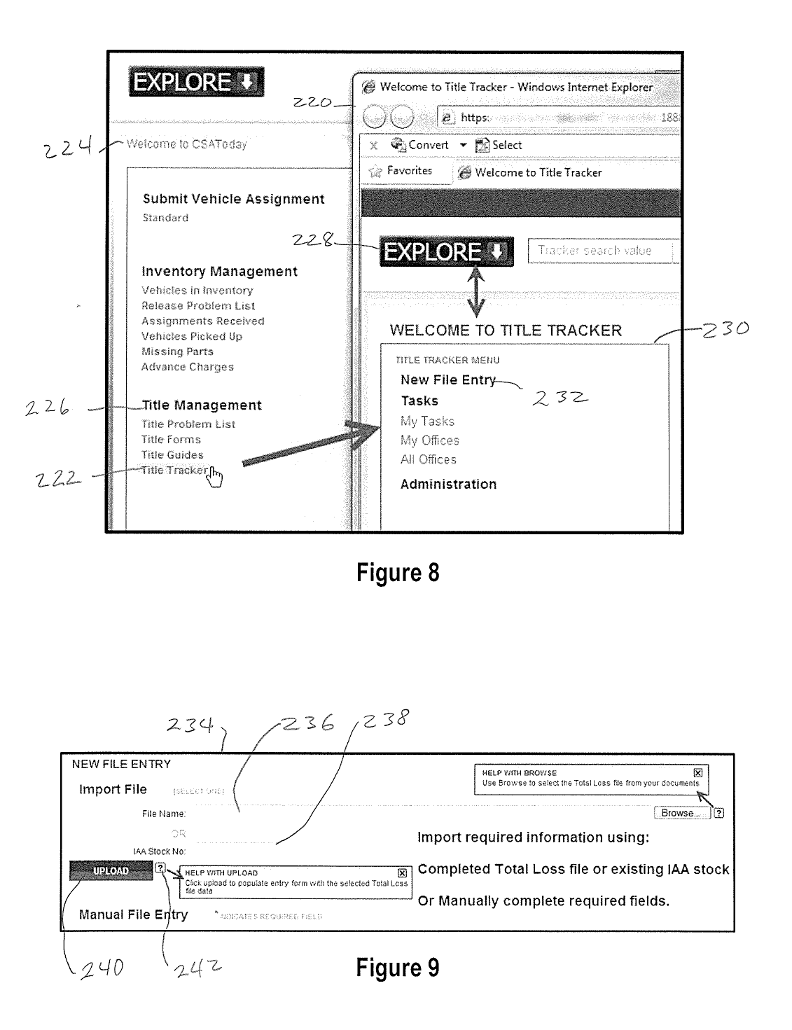

As noted above, the system may be customized to work with the procedures and documentation of a particular insurance company, or may be provided as a generic system to work with any insurance company. FIGS. 8-22 are provided as a user guide to a customized version of the system for a particular insurance company, here American Family insurance. Alternative embodiments are generic as to the insurance company or are customized to other insurance companies. The user is directed to enter information at the user interface screens and to proceed through the program to perform the method. The insurance company for which the customized version has been prepared accepts outside files as comma separated value files for a total loss worksheet. The instructions in the user guide and the system are customized for the particular connectivity that the insurance company uses.

In particular, the present system and method provides a workflow driven tool to assist insurance companies in the total loss process and securing the title and other necessary documentation for the claim. The user may start the process in one of three ways, by starting with a .csv file, by starting with a stock number of the auction service, or by starting with a blank file. The file is then assigned to a title handler and divided into appropriate, actionable tasks necessary to obtain a transferable title. Each task is designed as a status describing the next action needed to move the file forward. A file may begin in one task or in several depending on selections made at new file entry and whether the file is lien or non-lien. For example, a lien file will begin two task flows: 1. Track progress of obtaining lienholder paperwork 2. Track progress of obtaining owner paperwork. Each task flow progresses independently from the other. The tracker file advances as the tasks are completed or when the auction service receives transferable documents.

The system and method includes the features to add detailed information, including: to set follow-up dates on a task; to utilize a document tracking section to update obtained items; to add notes to track the progress or to share details (notes can remain private or be shared with the auction service); to generate a title problem task, which is identified by auction service branch, and which adds a visible warning as a task to file but also maintains a progression of the tracker workflow.

The system and method also provide file management assistance tasks, including: an indication that a follow-up is required: an indication that the tasks have reached their set follow-up date; an indication of a past due action required: an indication that tasks have exceeded a pre-set number of days to be worked; an indication of no activity or a follow-up date has been set; an indication of manager review aged tasks: an indication that tasks have exceeded the customer pre-set number of days; and an indication of email notification sent to a manager.

When the above features are added, the file will remain in the current task of the workflow. When the auction service receives transferable documents, the tracker file automatically advances to the end of the task flow-pending sale and settlement invoice. If not yet completed, the file also remains in an issue payment status and the lienholder release pending tasks until owner payment and lienholder payments are made. When the sale is complete and a settlement invoice is processed, the file moves to a review by the auction service settlement. Information is reviewed as needed and task completes to close file.

With reference to FIG. 8, the user may access the title tracker 220, by opening the title tracker program entry 222 from a menu 224, such as a menu on the customer interface of the auction service or other menu on which the title tracker program is provided, under a title management heading 226. An example of the customer interface is the website CSAToday. The title tracker 220 opens in a new window. This allows the user to use both a CSAToday program or other program and the title tracker 220 at the same time. In the title tracker window 220, the user is to click an explore button 228 which will open the title tracker menu 230. The image here displays the menu from the Tracker welcome page. To begin, the user is to choose the new file entry command 232.

This opens a new file entry dialog box 234 as shown in FIG. 9. The user is instructed to complete a file by: downloading information from a .csv file, by using a pre-filled generated from an existing auction service stock number, or by manually completing the file. The user enters a file name in space 236 or enters a stock number in space 238. The user may upload a file by selecting the upload button 240. A help button 242 provides assistance to the user in establishing the new file.

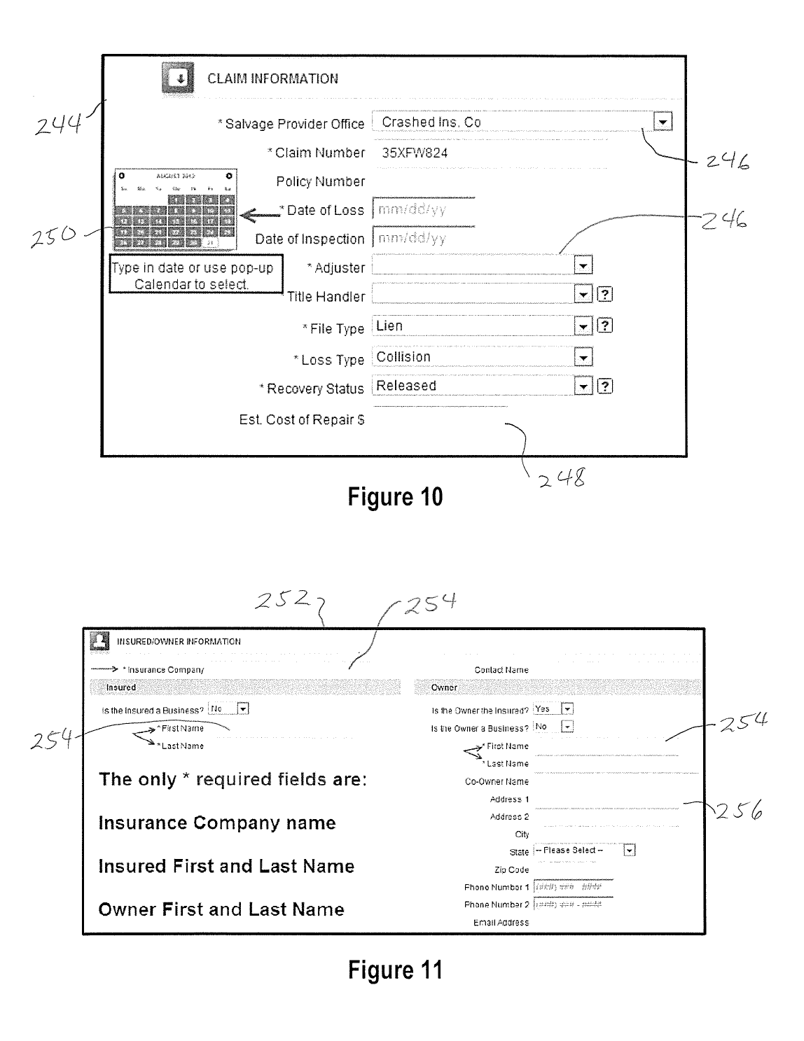

In FIG. 10, claim information is entered in a claim information dialog box 244. The following information is required in the displayed fields 246: salvage provider office, claim number, date of loss, adjuster, file type, loss type, and recovery status. The estimated cost of repair 248 is helpful but not required. There is a description text box that appears of an estimate is entered to add additional details regarding the estimate amount. Date information may be entered by selecting a date on a calendar pop-up 250.

An insured owner information entry box 252 is shown in FIG. 11. The required fields 254 are the insurance company name and the first and last name of the insured and the first and last name of the owner. Other information, such as address information, may be provided in non-required fields 256.

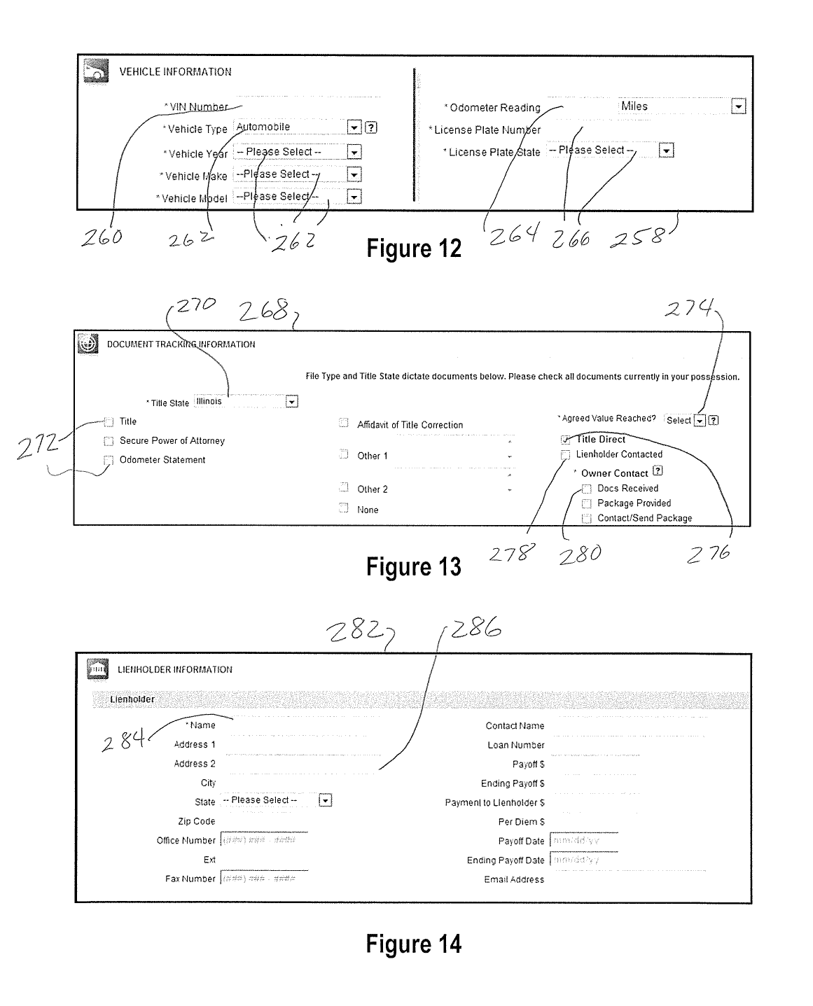

The user is required to enter all vehicle information into a vehicle information dialog box 258 in FIG. 12. By entering the vehicle identification number (VIN) in field 260, the system automatically decodes the VIN to fill in the vehicle type, year, make and model fields. An odometer field 264 is provided along with license plate number and state 266. If the odometer reading is unavailable, the user may enter a “0”.

FIG. 13 provides a document tracking information window 268. A title state entry 270 is vital to this section. The user selects the state in which the vehicle is to be titled in order to view the necessary documents of the transfer of the vehicle. The user is to check off whatever documents they have in hand at time of entry using check boxes 272. If the user has a document that is related but not listed, they are to use the “other” and description box options. The required documents for an exemplary state include a title, power of attorney, odometer statement, and affidavit of title correction, if any. The user is to indicate if an agreed value has been reached at field 274. If yes is entered, support staff begins title acquisition process; if no is entered, the system suspends the file from starting the title acquisition until a settlement value is reached with the customer. A title direct field 276 will be auto-checked and indicates inclusion of vehicle in the Title Direct program. A check box 278 is provided to indicate that the lienholder has contacted the owner. A checked box indicates that the owner has been contacted, while an unchecked box indicates a need to contact the owner. Several owner contact boxes 280 are also provided, to indicate documents received—meaning that the owner has been contacted, and all required titling documents are received. The user should check off any document already received in the tracking section and use “other” as needed. The owner contact boxes 280 also indicate that a package is provided, to indicate that the owner has been contacted and given a package to mail the docs to the auction service. The owner contact box 280 that indicates contact/send package means that the owner has not been contacted or given details on where to send the documents.

A lienholder information box 282 is provided in FIG. 14. The lienholder name is the only required field 284. The user is instructed to type “unknown” if they do not have this information. The other fields 286 may be automatically populated or may be populated later. For additional lienholders, the user may press an add lienholder button.

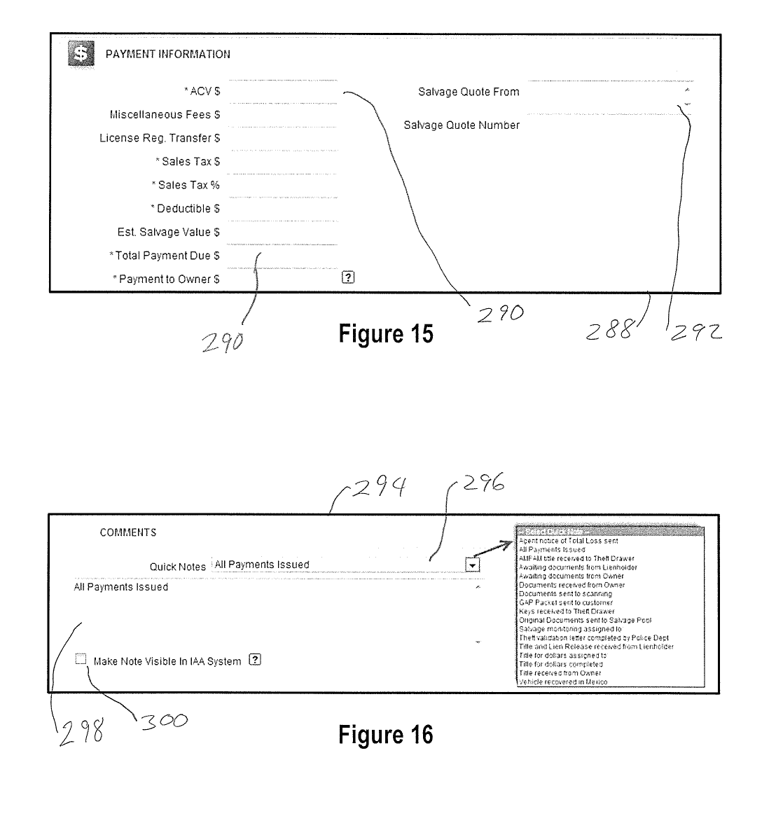

A payment information box 288 is shown in FIG. 15. The required fields 290 for this data entry box include the ACV amount, sales tax amount, sales tax percent, deductible amount, total payment due amount and payment to owner amount. Other fields 292 permit entry of salvage quote amount and number.

FIG. 16 permits the user to enter comments in a comments window 294. A quick notes pull down 296 provides a list of more common notes that a user may require. An example is a quick note saying all payment issued. A text field 298 accepts free form text entries. The notes may be shared with the auction service by checking a box 300.

Once the data entry windows have been filled in, the user selects a submit command. A reset command clears the data fields, if desired. Once the file is submitted, a confirmation is performed. A tracker confirmation page returns a unique tracker ID number. Additional options include: view details of file, submit new file to tracker, assign to auction service tracker file. The assign to auction service command takes details from the tracker file and automatically fills in most fields for a new CSAToday assignment. The user is to complete additional required fields for submission. The auction service stock number will be associated to the tracker file, enabling the auction service branch actions to move a tracker file through the task flow. If an auction service stock number already exists, the assign to auction service will not appear. The tracker file will be associated to the existing stock. The assign to the auction service command may be entered from the vehicle detail information page.

The assignment type, such as the CSA Today Assignment type, is determined by the recovery status. If the status is released, unreleased and hold then the vehicle is assigned for pick up. If the status is owner retained and unrecovered theft, the vehicle is assigned for title processing only.

The task list may be accessed by a corresponding command in FIG. 8, by selecting the task list command. The tasks command displays the user's tasks, the offices command displays the tracker files for the user's offices, the all offices command displays all of the tracker files. The task list may be displayed by a group, by a person, by an office or for all offices. This enables co-workers to cover each other's workloads. The view may be changed as desired. Additional filters are provided by filtering to display task files in process that are not yet completed or tasks that are not yet started.

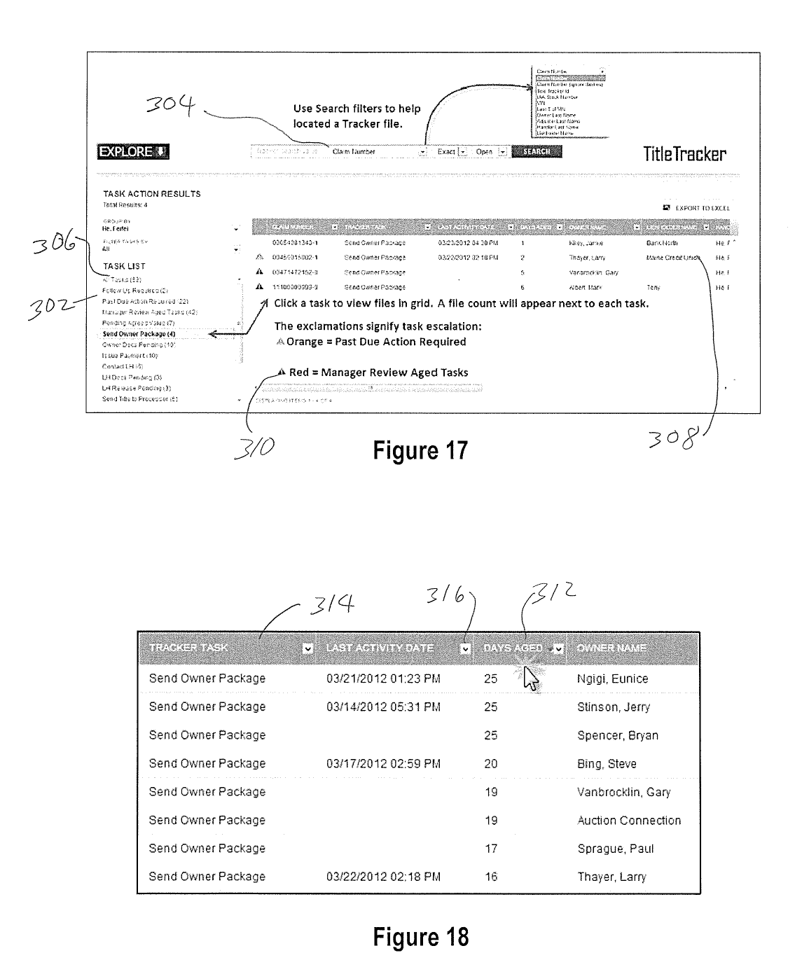

Turning to FIG. 17, a task list 302 search may be performed to filter displayed results by a characteristic, such as a claim number, stock number, VIN, adjuster name, etc. using a drop down box 304. A task list portion 306 entry may be highlighted to view the files 308 within that task list in a grid arrangement. Each task list includes an indication of the number of files in the list. Past due tasks and manager reviewed tasks are displayed by distinctive symbols 310.

FIG. 18 shows that the tasks are presented in columns which permit sorting by column data. A column 312 showing the days aged for a task is selected, causing the data to be sorted and displayed in descending date order. A second selection of the column results in an ascending sort based on the column. The columns 314 may be filtered by selecting a column header. Pull down selectors 316 permit values to be selected that are used as filters, for example to sort by a lienholder. A clear command is provided to turn off filtering.

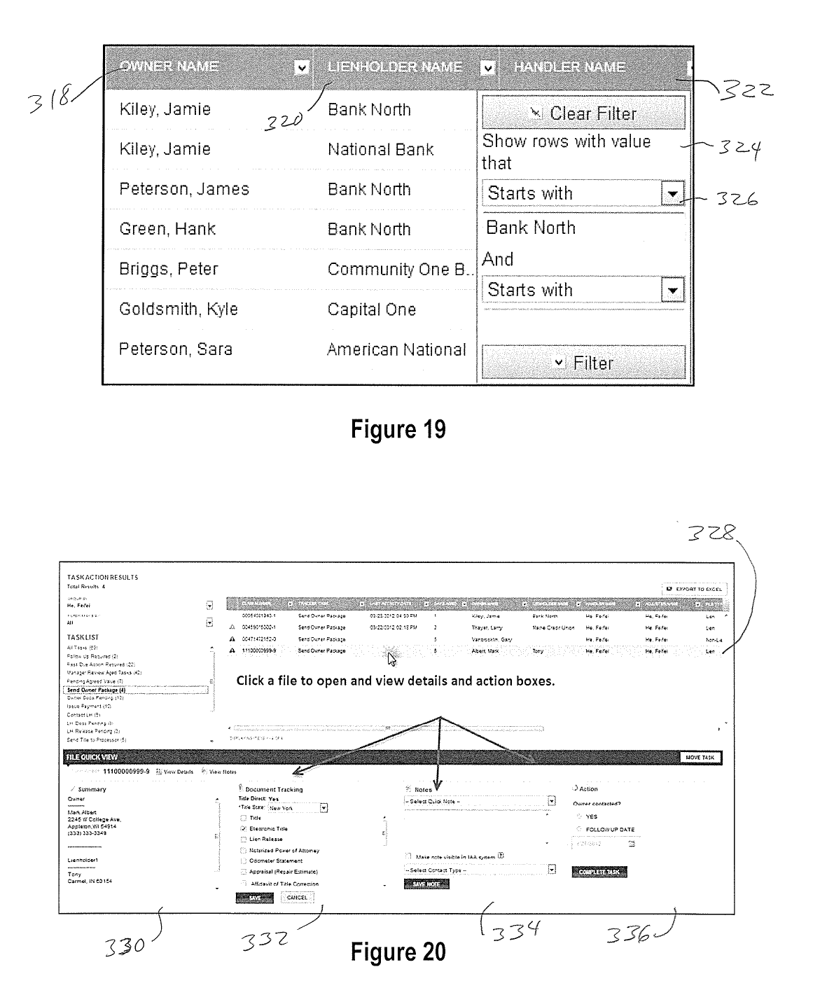

FIG. 19 also shows filtering, for example by handler's name 318, lienholder name 320, or owner name 322. A filtering options box 324 permits the user to select filtering options by a drop down box 326 that includes the options of filtering by a starts with command, an equal to command, a not equal to command, and a contains command. A sort and filter command is provided, which will reset when a new task is selected or a new search is performed. The search results may be output to a spreadsheet program such as Excel.

With reference to FIG. 20, a task 328 is selected, which displays a summary box 330, document tracking box 332, notes box 334 and an action box 336 for the task. In the summary 330, contact information for the owner and lienholders is shown, along with quick view to notes tracking progress. Quick view notes do not include tracker events, task movements, or auction service branch notes. In the document tracking 332, a view and update of state-specific documents obtained may be seen. In the notes 334, capture notes, submit quick notes, flag contact type (e.g. US Mail, phone, fax) are provided. In the action portion 336, an indication of whether this is a complete task or not and a chance to set follow-up dates. The display may also show a title problem task that includes a link to a title problem page, such as the CSAToday title problem detail page. A send title to processor task display includes links to a title transmittal sheet, such as the CSAToday title transmittal sheet.

A quick view selection for accessing the file may be provided by selection of either a details view or a notes view. A move task command may be provided to manually move the file to another task within the task flow, or to cancel the file. The user may move the tracker file to the owner doc's obtained or LH doc's obtained tasks to reach the send the title to processor task or any task beyond that step in the process.

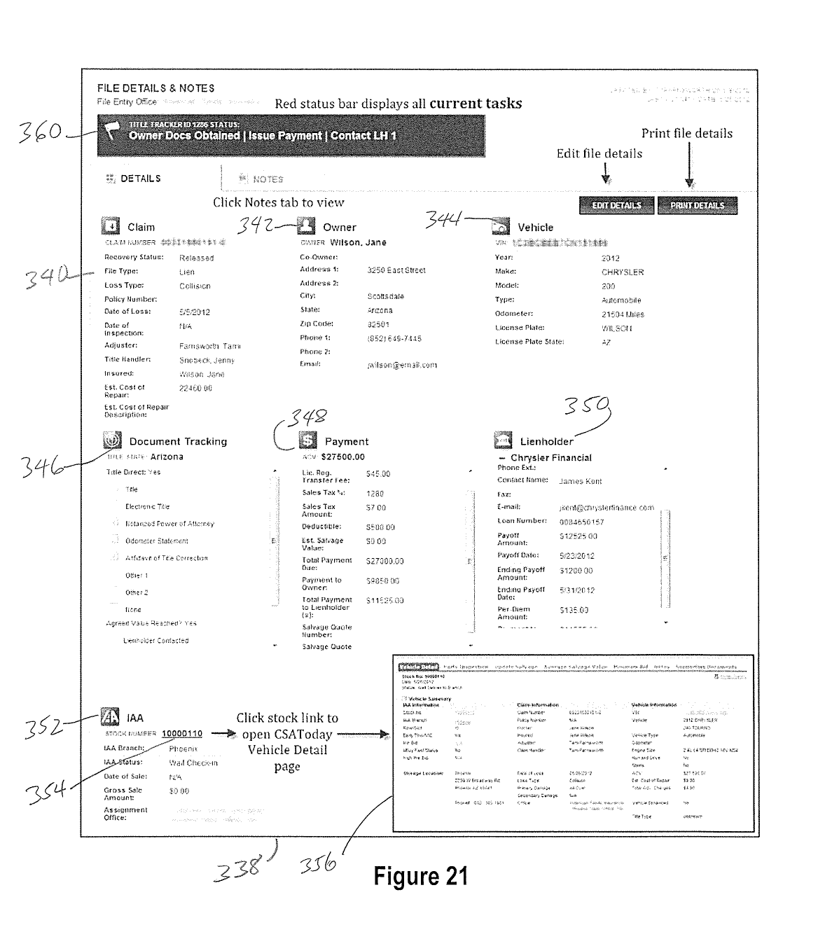

The details view 338 of FIG. 21 assembles the claim information 340, owner information 342, vehicle information 344, document tracking 346, payment information 348 and lienholder information 350 on a single screen for consideration by the user. The auction service information 352 includes a stock number link 354 that when selected opens a window 356 that includes detailed information about the vehicle drawn from the information provided by the auction service company. A status flag 360 is displayed at the top of the detail view that gives the current status of the vehicle claim.

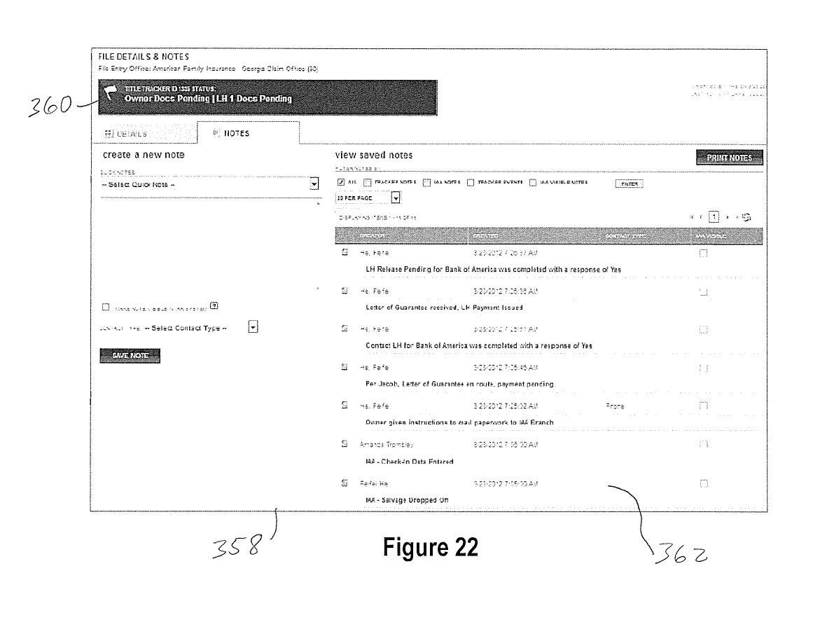

In a notes display 358 as shown in FIG. 22, any notes that have been added to the tracker file are displayed. The status flag 360 is shown at the top. Individual notes 362 may be selected for display.

Further tools are provided for the user to work with the information in the tracker file, including a filter selector to select the type of notes displayed, including only tracker notes, only auction service notes, only tracker events, only auction service visible notes. The user may set the number of notes displayed per page.

The user may add notes using a quick notes function to enter commonly used notes that are loaded into a quick note drop down for ease. Quick notes are set for each customer and are available to all staff. The administrator can rearrange, edit, or add new notes. Notes may be made visible to the auction service or not. Private notes may be provided. If this function is selected, the note will be visible to the auction service staff once the auction service stock is created. If an auction service stock already exists, the note displays immediately. Contact type information may be added to a note by setting a flag a contact type to capture in note. The user is informed that when branch action is needed on a note, add the note to the auction service stock from CSAToday and the branch will receive system email. Title tracker notes do not email branch.

In the foregoing, a tracker system has been provided for a particular insurance company according to that insurance company rules and procedures. A version of the tracker program is also provided as a generic version of the system. The company specific connectivity portions are made generic rather than being directed to a specific data format and connectivity type.

Thus, there is shown and described a method and apparatus for tracking transfer of ownership of a damaged vehicle. The method and apparatus may also generate documents for use in the transfer of the vehicle ownership.

Although other modifications and changes may be suggested by those skilled in the art, it is the intention of the inventors to embody within the patent warranted hereon all changes and modifications as reasonably and properly come within the scope of their contribution to the art.

We claim:

1. A method for tracking a transfer of ownership of a damaged vehicle, comprising the steps of:
in a programmed computer, providing a network connected user interface to access by a user to a vehicle transfer tracking system;
receiving information at the user interface regarding a damaged vehicle;
receiving information at the user interface regarding an insurance company that insures the damaged vehicle;
receiving information at the user interface regarding a state of title for the damaged vehicle;
in the programmed computer, automatically generating a task list at the user interface of tasks specific to the vehicle and the insurance company and the state; and
in the programmed computer, tracking completion of the tasks on the task list at the user interface.

2. A system for tracking titles of damaged vehicles by an insurance company, comprising:
a database of requirements for title transfers of vehicle titles for a plurality of jurisdictions;
a user interface of a computer device that accesses the database, the user interface including means for tracking communications to parties required for a transfer of a vehicle title and for reporting to a user on a status of title transfer communications; and
a document review function for automatic review of received documents relating to transfer of a vehicle title.
